(19) United States
(12) Patent Application Publication
(10) Pub. No.: US 2004/0205364 A1
(43) Pub. Date: Oct. 14, 2004

(54) Secure apparatus for data safety

(75) Inventor: Kuen-Chu Lai, DaLi City (TW)

Correspondence Address: Ladas & Parry, 26 West 61st Street, New York, NY, 10023, US

(73) Assignee: W-CHANNEL INC.

(21) Appl. No.: 10/668,548

(22) Filed: Sep. 23, 2003

(30) Foreign Application Priority Data
Apr. 8, 2003 (TW) 092205473

(51) Int. Cl. G06F 1/26

(52) U.S. Cl. 713/300

(57) ABSTRACT

A secure apparatus for data safety comprises a power switch device, a first network card, a second network card, and a data storage device. The power switch device has a first power output and a second power output, for switching the first power output and the second power output to output power non-simultaneously. The first network card is powered by the first power output, and its machine address is bound with an IP address. The second network card is powered by the second power output, and its machine address is bound with another IP address. The data storage device comprises two data storage components respectively powered by the first and the second power output of the power switch device, for respectively storing the data sourced from the first network card and the second network card, wherein the data storage device further provides a connecting line linking to a mainboard for transmitting data to the mainboard.

### BACKGROUND OF THE INVENTION

1. Field of the Invention

This invention generally relates to the field of network data safety. More particularly, the present invention relates to a secure apparatus for data safety by physically separating the data from different sources and operating systems.

2. Description of the Prior Art

Since Internet technology is progressing and developing rapidly, various applications there are becoming popular. As computer equipments are for providing information services, or searching useful data via network or Internet, how to protect the internal data of a computer and ensure that the internal data would not overflow or be stolen by other users is an important issue concerning Internet data safety.

Network equipments linking to the Internet, such as a personal computer, the internal data thereof is easily invaded and stolen by an outside user (like a hacker) via network. Computer viruses or back door programs can be easily embedded to a computer; consequently, the internal data may be stolen or damaged unknowingly through network linking. Even though many network security apparatus have been presented, there still exist the possibility and the risk that the internal data may be stolen when the computer is connected to a network or the Internet.

So far, most personal computers only provide a signal network card, and most personal computers and workstations have data storage devices (such as hard disk) for storing an operating system and operating data. Accordingly, the previous network card will be the only one data route passed through as a personal computer accesses a WAN (such as the Internet) or LAN (such as enterprise network). In other words, the data source from a WAN or LAN will pass through the same network card into the personal computer, and then be stored on the same hard disk. Normally, the virus or the back door program gets into the personal computer and waits for the opportunity to steal the data stored therein, or intentionally damages the data.

Accordingly, a secure apparatus for data safety, capable of completely separating data from different sources, such as WAN or LAN, is needed.

### SUMMARY OF THE INVENTION

In view of the above, the present invention provides a secure apparatus for data safety by physical separation, which utilizes at least two sets of network cards, and data storage devices with the operating system stored therein, so as to completely separate the data from different sources (such as ones sourced from WAN or LAN). Accordingly, the data will not be shared, and so the data independency can be assured to achieve the purpose of data safety, i.e., an outside user cannot steal or damage internal data through the Internet.

The present invention provides a secure apparatus for data safety comprising a power switch device, a first network card, a second network card, and a data storage device. The power switch device has a first power output and a second power output for switching the first power output and the second power output to output power non-simultaneously. The first network card is powered by the first power output, and its machine address is bound with an IP address. The second network card is powered by the second power output, and its machine address is bound with another IP address. The data storage device comprises two data storage components respectively powered by the first and the second power output of the power switch device, for respectively storing the data sourced from the first network card and the second network card, wherein the data storage device further provides a connecting line linking to a mainboard for transmitting data to the mainboard.

### BRIEF DESCRIPTION OF THE DRAWINGS

The foregoing aspects and many of the attendant advantages of this invention will become more readily appreciated as the same become better understood by reference to the following detailed description, when viewed in conjunction with the accompanying drawings, wherein:

FIG. 1 illustrates a preferred embodiment of the present invention;

FIG. 2 illustrates that the present invention utilizes dual DOC board as the data storage device; and

FIG. 3 illustrates that the present invention utilizes dual DOM/CF board as the data storage device.

### DESCRIPTION OF THE PREFERRED EMBODIMENT

One embodiment of the invention will now be described in greater detail. Nevertheless, it should be noted that the present invention can be practiced in a wide range of other embodiments besides this embodiment explicitly described, and the scope of the present invention is not expressly limited except as specified in the accompanying claims.

So far, most network equipments only provide a single network card to simultaneously connect to a WAN and LAN. However, the data from WAN or LAN will be stored on the same disk under one operating system. Even though there is more than one network card, the data from WAN and LAN will still be stored on the same hard disk. The virus or back door program usually attacks the data stored on hard disk by firstly infecting a storage device, such as a disk on chip (DOC), a disk on module (DOM), a CF card, a CMOS, etc. Most of DOC, DOM, CF, and CMOS commonly employ flash technique to write in data; therefore, the computer virus or the back door program may wait for the opportunity to be written into DOC, DOM, CF, or CMOS to steal the data from outside via the Internet.

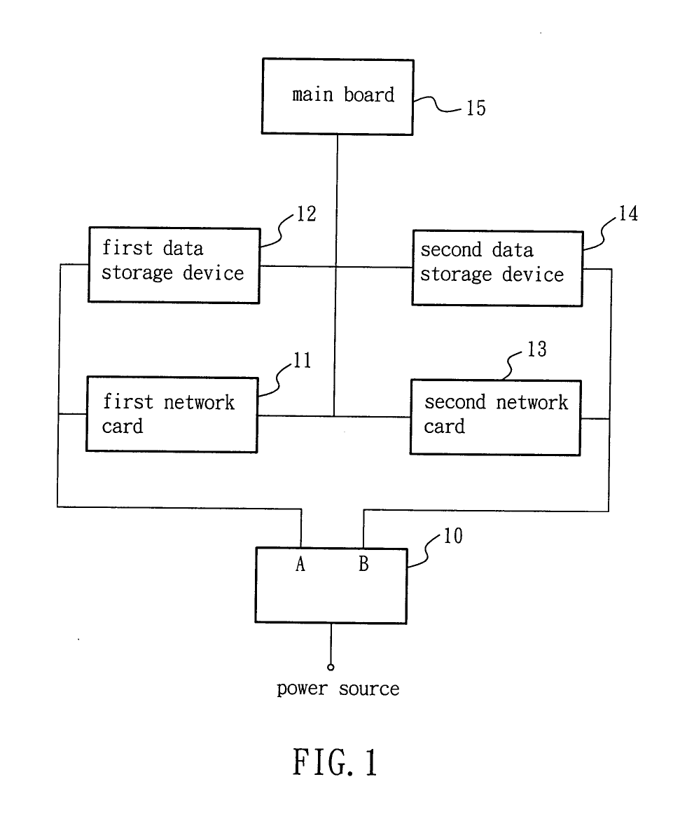

FIG. 1 is a preferred embodiment of the present invention, wherein the power switch device 10 is used to switch to different power sources; accordingly, the power source A and the power source B cannot be simultaneously outputting power. In other words, since the power source A supplys power to the first network card 11, and the first data storage device 12 has a operating system stored therein, the power source B stops supplying power to the second network card 13 and the second data storage device 14. Therefore, only the network card and the data storage device disposed on the same side will be powered.

The first network card 11, the first data storage device 12, the second network card 13, and the second data storage device 14, all connect to the mainboard 15. The first data storage 12 is only used to store the data from the first network card 11, and the second data storage 14 is only used to store the data from the second network card 13. For the reason that the power switch device 10 merely supplys power for one side at a time, it can be ensured that when the user utilizes the first network card 11 and the first data storage device 12 to access WAN, the second network card 13 and the second data storage device 14 for accessing LAN are disabled, i.e., it is impossible to write the data sourced from WAN into the second data storage device 14. The machine address (MAC) of the first network card 11 and second network card 13 are each bound with an IP address to avoid the safety defect caused by change of IP address and to certainly separate the data routes to WAN and LAN. The CMOS disposed on the mainboard 15 is used to store the basic I/O system (BIOS), wherein the data writing-in pin of the CMOS uses a jumper to decide whether data is permitted to be written in the CMOS, so as to ensure that the BIOS would not be changed from outside.

The first data storage device 12 and the second data storage device 14 are mainly used to store the data either sourced from network or produced by internal computer operating. The data storage device disclosed in the preferred embodiment can be a DOC, DOM, CF card, and so on.

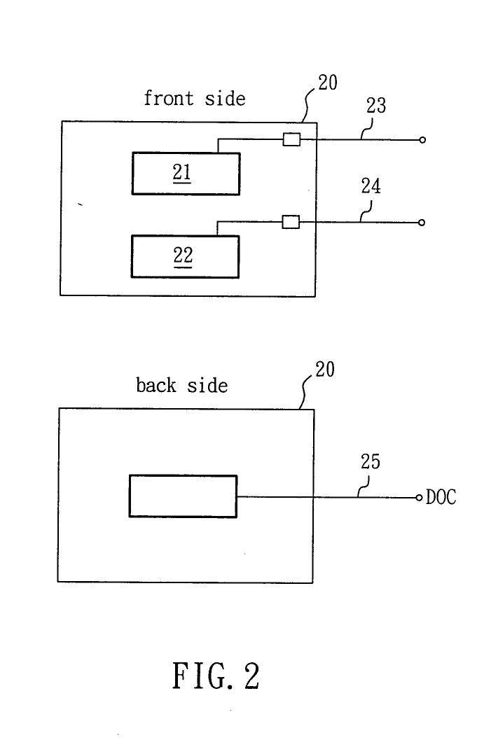

The present invention further discloses various embodiments using different storage media to be the data storage device. FIG. 2 illustrates that a dual DOC board 20 has replaced the first data storage device 12 and the second data storage device 14 shown in FIG. 1. As shown in FIG. 2, the front side of the dual DOC board 20 has a first DOC 21 and a second DOC 22. The power input 23 of the first DOC 21 connects to the power source A of the power switch device 10, and the power input 24 of the first DOC 22 connects to the power source B of the power switch device 10. The first DOC 21 is used to store and activate the data sourced from the first network card 11, and the second DOC 22 is used to store and activate the data sourced from the second network card 12. Since the first DOC 21 and the second DOC 22 will not be powered simultaneously, only one DOC with the operating system stored therein will be operated and activated at a time. A data output line disposed on the backside of the dual DOC board 20 links to a DOC receiver 25 of the mainboard 15 for transmitting data. According to the above, by employing the dual DOC board 20, the data sourced from different network cards can be physically separated, and the operating systems stored therein can be activated respectively, so that the data safety can be ensured.

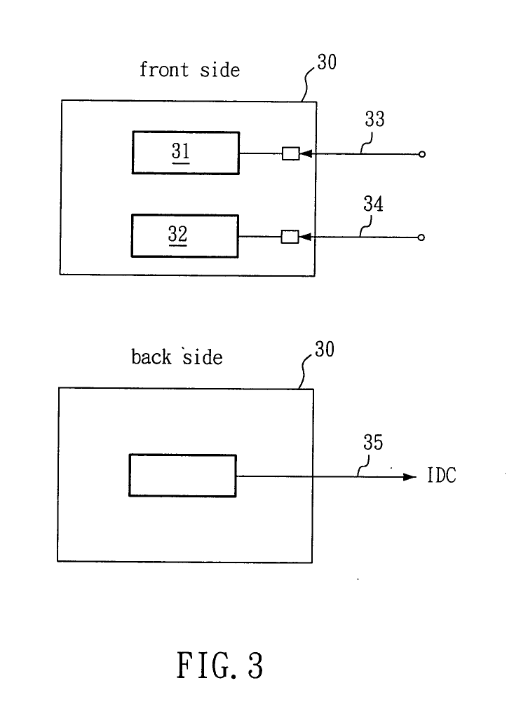

Similarly, FIG. 3 illustrates another embodiment of using dual DOM/CF board 30 to be the data storage device, wherein the front side of the dual DOM/CF board 30 has a first disk on module (DOM) 31 and a second DOM 32, and the DOM can be replaced with a CF card. The power input 33 of the first DOM 31 connects to the power source A of the power switch device 10, and the power input 34 of the second DOM 32 connects to the power source B of the power switch device 10. The first DOM 31 is used to store and activate the data sourced from the first network card 11, and the second DOM 32 is used to store and activate the data sourced from the second network card 12. Since the first DOM 31 and the second DOM 32 will not be powered simultaneously, only one DOM with the operating system stored therein will be operated and activated at a time. A data output line disposed on the backside of the dual DOM board 30 links to the internal data bus connector (IDC) 35 of the mainboard 15 for transmitting data. Although the present invention utilizes the foregoing storage media disclosed in the embodiments to be the data storage device, it is not limited to use other storage media to achieve the same intention and effect.

According to the above description, the present invention discloses a secure apparatus using at least two network cards and the corresponding data storage devices having operating systems respectively stored therein, to physically separate and store the data from different sources and different operating systems. Therefore, the data independency can be assured, so as to achieve the goal of data safety, and the outside user cannot steal or damage the internal data of a computer via the Internet.

Although specific embodiments have been illustrated and described, it will be obvious to those skilled in the art that various modifications may be made without departing from what is intended to be limited solely by the appended claims.

What is claimed is:

1. A apparatus for data safety, comprising:
a power switch device, having a first power output and a second power output, for switching an input power to ensure that side first power output and side second power output do not supply power simultaneously;
a first network card, powered by said first power output of said power switch device;
a first data storage device, powered by said first power output of said power switch device, for storing the data sourced from said first network card, and for activating an operating system;
a second network card, powered by said second power output of said power switch device; and
a second data storage device, powered by said second power output of said power switch device, for storing the data sourced from said second network card, and for activating an operating system.

2. The apparatus according to claim 1, wherein the machine address of said first network card and said second network card are each bound with an IP address.

3. The apparatus according to claim 1, wherein said first data storage device is selected from the group consisting of disk on chip, disk on module, and compact flash memory.

4. The apparatus according to claim 1, wherein said first data storage device is selected from the group consisting of disk on chip, disk on module, and compact flash memory.

5. A apparatus for data safety, comprising:
a power switch device, having a first power output and a second power output, for switching an input power to cause said first power output and said second power output do not supply power simultaneously;
a first network card, powered by said first power output of said power switch device, the machine address of said first network card being bound with an IP address;
a second network card, powered by said second power output of said power switch device, the machine address of said second network card being bound with an IP address; and
a data storage device, comprising two data storage components respectively powered by said first power output and said second power output of said power switch device, for respectively storing the data sourced from said first network card and said second network card, wherein said data storage device further provides a connecting line linking to a mainboard for transmitting data to said mainboard.

6. The apparatus according to claim 5, wherein said data storage device is selected from the group consisting of disk on chip, disk on module, and compact flash memory.
